(19) United States
(12) Patent Application Publication
(10) Pub. No.: US 2002/0000934 A1
(43) Pub. Date: Jan. 3, 2002

(54) METHOD FOR MOUNTING PATCH ANTENNA

(76) Inventors: JOSEPH P. MENDELSOHN, ENGLISHTOWN, NJ (US); RICHARD F. SCHWARTZ, CRANBURY, NJ (US)

Correspondence Address: RICHARD C WOODBRIDGE ESQ, WOODBRIDGE & ASSOCIATES PC, PO BOX 592, PRINCETON, NJ, 085420592

(21) Appl. No.: 09/470,202

(22) Filed: Dec. 21, 1999

(51) Int. Cl. H01Q 1/48

(52) U.S. Cl. 343/700 MS; 343/846

(57) ABSTRACT

This invention relates to an improved design and method of manufacture of patch antenna assemblies which incorporates projections, or tabs, to the sides of the antenna patches to facilitate mounting to the antenna structure, thereby reducing the total number of parts used in the antenna assembly.

### BACKGROUND OF THE INVENTION

1. Field of the Invention

This invention relates to a patch antenna structure, and a method of construction thereof.

2. Description of Related Art

The uses of antennas continue to increase with reductions in antenna size and cost, and the development of complimentary microwave designs. For size reduction, “patch” antennas are of particular interest. Patch antennas generally comprise a dielectric substrate, an electrically conductive ground layer disposed below the dielectric substrate, and an electrically conductive patch antenna element disposed over the dielectric substrate. The patch antenna element may be coupled to an RF feed means using any of several conventional methods such as a coaxial cable. A multiple frequency antenna may be constructed by “stacking” patch elements with intermediate dielectric layers.

Typical prior art methods of mounting the patch antenna over the dielectric substrate employ a frame mechanism to hold the patches. Alternative methods have patches etched on a printed circuit board, which itself requires a support structure. Accordingly, these and other prior art methods typically rely on screws, plastic inserts or mounting frames for attaching the patch antenna, using manual assembly techniques.

### SUMMARY OF THE INVENTION

This invention relates to an improved patch antenna assembly which reduces the cost of manufacturing antennas by reducing or eliminating extra parts used to hold the patches. This is accomplished by reducing the number of patch elements by forming them from a single metal sheet thereby allowing machine assembly and corresponding reductions in assembly time.

These and other features of the invention will be more fully understood by reference to the following drawings.

### BRIEF DESCRIPTION OF THE DRAWINGS

FIG. 1 illustrates an antenna patch with fold down tabs according to the preferred embodiment of the invention.

FIGS. 2A and 2B illustrate alternative tab snap locking features.

FIG. 3 depicts an exemplary sheet pattern for a 2×4 array.

FIG. 4 depicts greater detail of a tab element of FIG. 3.

### DETAILED DESCRIPTION OF THE INVENTION

During the course of this description, like numbers will be used to identify like elements according to different figures which illustrate the invention.

The present invention relates to a change to the design of antenna “patches”, which are radiating elements used in a class of antennas known as patch antennas. In the preferred embodiment of the present invention, these patches are placed directly onto parts of the antenna, such as the feed networks, without any of the intervening support mechanisms that are required in prior art patch antenna assemblies. This is accomplished by incorporating projections, or tabs, at the sides of the antenna patches to facilitate mounting to the antenna structure. Use of these tabs reduces the total number of parts used in the antenna assembly. Further, these tabs simplify assembly of the antenna structure as the length of the tabs can be used to set the height of the patch above the dielectric substrate. In addition, this tab feature readily permits patches to be connected together in a series arrangement.

Consequently, this design allows the patches/antenna to be combined with a printed circuit board used for purposes besides that needed by the antenna; e.g., the patches and antenna could be combined into the printed circuit board used by radio circuits. Also, the entire antenna assembly can now be performed by using the same surface mount production equipment as is used for standard assembly of other printed circuit boards.

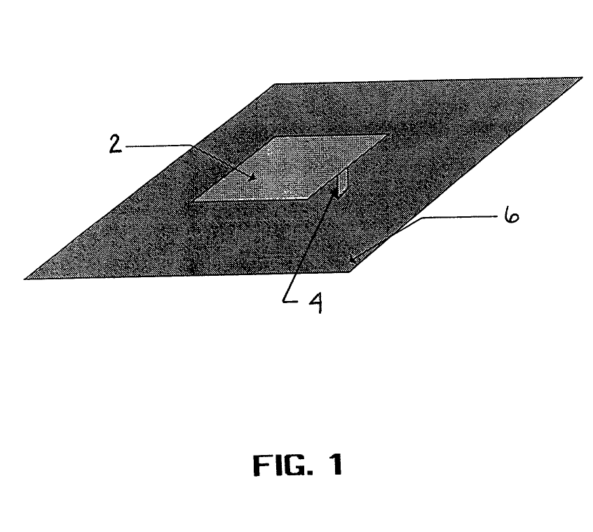

FIG. 1 illustrates an antenna patch 2 with fold down tabs 4 according to the preferred embodiment of the present invention. The patch can be stamped and formed out of sheet metal. The folded down tabs interlock with a PCB or other distribution structure 6. Use of such patch tabs to install the antenna patch in this manner takes advantage of the voltage null in the middle plane of the patch and accordingly, does not appreciably impact on the performance of the resulting antenna assembly.

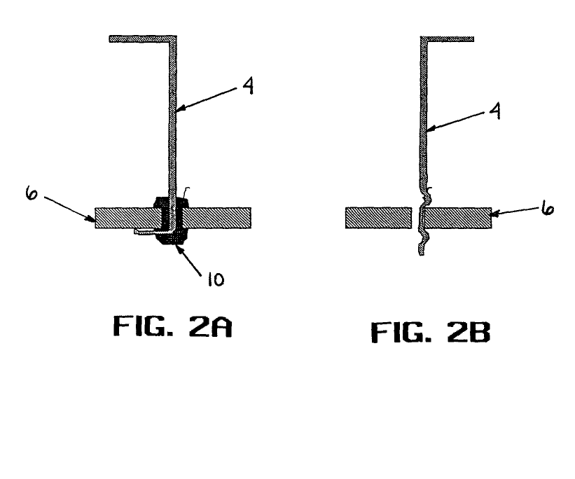

The tabs 4 can be held with an interlock feature, soldered, welded or held with adhesive epoxy or plastic. FIGS. 2A and 2B illustrate two such interlock features. FIG. 2A depicts a locking attachment wherein a soldered connection 10 is made between the tab 4 and the PCB 6. An alternative locking arrangement is illustrated in FIG. 2B, which incorporates a snap arrangement which does not require the use of solder.

For soldered applications, the patches could be left on the surface of the PCB 6 without through holes and accordingly, can be produced using a standard surface mount technology (SMT) assembly line. For example, patches can be installed in tape and reel feeders and placed automatically on the PCB. Such SMT technology greatly reduces manufacturing costs.

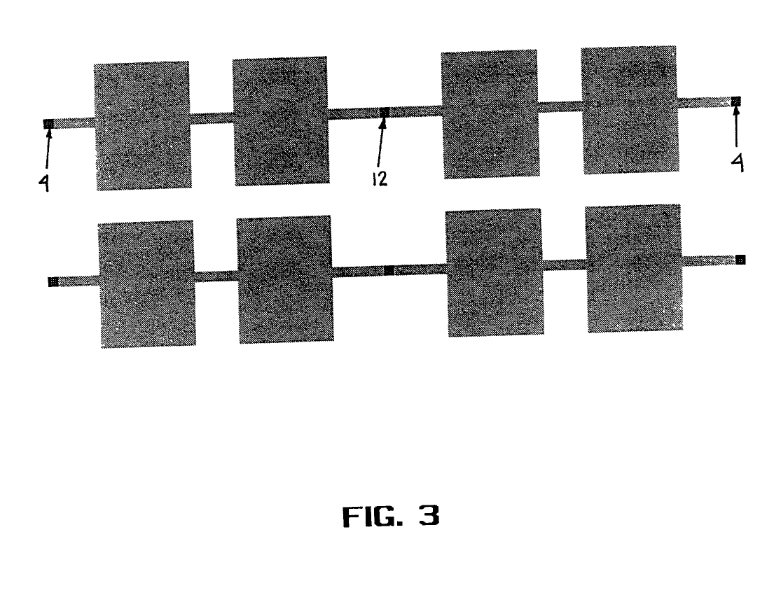

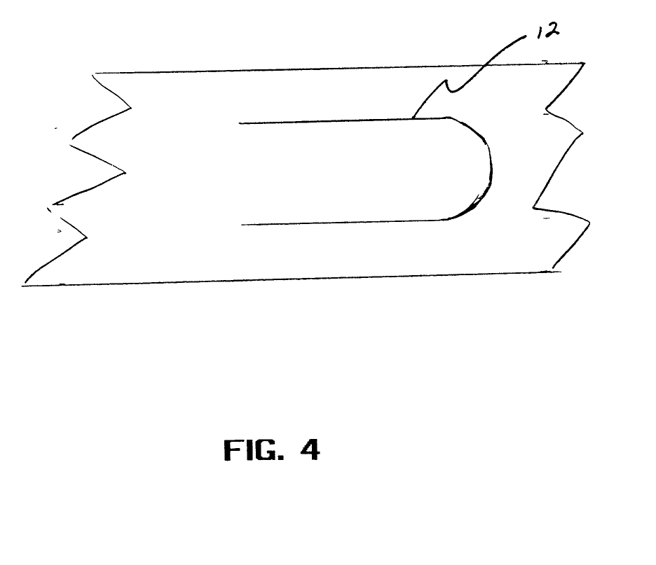

As depicted in FIG. 3, arrays of antennas, which include the locking features of the present invention, can be stamped from a single sheet. In such an arrangement, the tabs appearing at the ends of the array are the same tabs 4 previously discussed above. Tabs 12 which appear in between patch elements would, in the preferred embodiment, be stamped in a U-shaped fashion as depicted in FIG. 4. Accordingly, these tabs could then be folded and utilized in same manner as tabs 4 while the structural integrity of the antenna array is maintained.

While the invention has been described with reference to the preferred embodiment thereof, it will be appreciated by those of ordinary skill in the art that various modifications can be made to the structure and function of the individual parts of the system without departing from the spirit and scope of the invention as a whole.

We claim:

1. A patch antenna structure comprising:
(a) a first electrically conductive plate, which serves a ground plane; and,
(b) a second electrically conductive plate, which serves as a patch antenna element, said second plate having one or more tabs;
whereby said one or more tabs support said second plate in a substantially parallel relationship above said first plate.

2. The antenna defined in claim 1, wherein said first plate is at least as large as said second plate.

3. The antenna defined in claim 1, wherein said second plate is substantially rectangular in shape having said one or more tabs located about the periphery thereof.

4. The antenna defined in claim 1, further comprising one or more locking means whereby said one or more tabs interconnect with said first plate.

5. The antenna defined in claim 1 wherein said one or more tabs does not establish an electrical connection between said first and second plates.

6. The antenna defined in claim 1 wherein said one or more tabs does establish an electrical connection between said first and second plates.

7. A process for manufacturing an antenna structure comprising the steps of:
(a) providing a substrate;
(b) supplying a patch antenna element having one or more tabs; and,
(c) mounting said patch antenna element to the substrate.

8. The process of claim 7, wherein said supplying step comprises stamping the patch element and said tabs from a single sheet.

9. The process of claim 8, wherein said mounting step comprises folding said tabs to thereby support said patch antenna element in a substantially parallel relationship with said substrate.

10. The process of claim 9, wherein the distance between said patch antenna element and said substrate is substantially determined by the length of said one or more tabs.

11. The process of claim 10, wherein said mounting means comprises use of through holes in the substrate.

12. The process of claim 10, wherein said mounting means is effected without the use of through holes in the substrate.

13. The process of claim 12, wherein the mounting step is effected using a standard SMT assembly process.

14. The process of claim 10, wherein said mounting step further comprises establishing an electrical connection between said substrate and said patch antenna element.

15. The process of claim 10, wherein said mounting step further comprises electrically insulating said substrate from said patch antenna element.

16. A process for manufacturing an antenna structure comprising the steps of:
(a) providing a substrate;
(b) supplying a patch antenna element array having one or more tabs; and,
(c) mounting said patch antenna element array to the substrate.

17. The process of claim 16, wherein said supply step comprises stamping the patch element array and tabs form a single sheet.
